(19) United States
(12) Patent Application Publication
(10) Pub. No.: US 2018/0181913 A1
(43) Pub. Date: Jun. 28, 2018

(54) SHELF ALLOCATION ASSISTANCE DEVICE, SHELF ALLOCATION ASSISTANCE SYSTEM, SHELF ALLOCATION ASSISTANCE METHOD, AND RECORDING MEDIUM

(71) Applicant: NEC Corporation, Tokyo (JP)

(72) Inventors: Kyota HIGA, Tokyo (JP); Takami SATO, Tokyo (JP); Kota IWAMOTO, Tokyo (JP); Yaeko YONEZAWA, Tokyo (JP); Minoru TOGO, Tokyo (JP)

(21) Appl. No.: 15/580,948

(22) PCT Filed: Jun. 7, 2016
(86) PCT No.: PCT/JP2016/002754

§ 371 Date: Dec. 8, 2017

(30) Foreign Application Priority Data
Jun. 9, 2015 (JP) 2015-116477

(51) Int. Cl. G06Q 10/08; G06Q 10/06

(52) U.S. Cl. CPC G06Q 10/0875; G06Q 10/06315

(57) ABSTRACT

Provided is a feature for generating a recommended shelf allocation indicating the state in which products are displayed, the recommended shelf allocation including a state in which specified products are displayed in more effective positions. The present invention is provided with: a generation means for generating a plurality of shelf allocation candidates indicating the state in which a plurality of products including the specified products are displayed on product shelves; a prediction means for predicting the sales of the specified products for the plurality of shelf allocation candidates, on the basis of the positional relationships among the products displayed on the product shelf, and of the relationships with sales of the products; and a selection means for selecting the shelf allocation candidates on the basis of the results of the predictions.

### TECHNICAL FIELD

The present invention relates to a shelf allocation assistance apparatus, a shelf allocation assistance system, a shelf allocation assistance method, and a recording medium.

### BACKGROUND ART

Sales in a retail store, such as a convenient store and a supermarket, are greatly affected by locations where products are displayed, Accordingly, locations where products are displayed on product shelves are frequently changed. The locations where the products are displayed may be changed by using information about sales prediction and the like based on the locations where the products are displayed.

PTL 1 describes a method for predicting sales for each shelf, based on sales prediction information for each product based on an actual sales result of the product, and sales information for each shelf stage of each shelf in a store.

PTL 2 describes that i correspondence relation condition for placing products with good sales on well-selling places on the shelf, by using ranking of sales for each product and ranking of sales for each position of the shelf, is set, and a state where products are displayed in accordance with the set correspondence relation condition is displayed and output.

In addition, a method for simulating a product display state by using products and PI (Purchase Index) values of the products is described in, for example, PTL 3.

### CITATION LIST

### Patent Literature

PTL 1: Japanese Unexamined Patent Application Publication No. 2004-151955

PTL 2: Japanese Unexamined Patent Application Publication No. 2010-33114

PTL 3: Japanese Unexamined Patent Application Publication No. H08-278997

### SUMMARY OF INVENTION

### Technical Problem

Sales of a product may vary depending on a position of a shelf stage on which the product is displayed. Accordingly, even when a specified product (e.g., a product desired to be sold by a seller) is displayed on a well-selling stage on the shelf, actual sales of the specified product are not always good,

In the techniques of PTLs 1 to 3 described above, how to display the specified product to make it sold good is not taken into consideration.

The present invention has been made in view of the above-mentioned problem, and an object of the present invention is to provide a technique for generating recommended shelf allocation of products on the shelf, indicating a display state of the products, including a state representing that a specified product is displayed on the shelf in such a manner to make the products sold good.

### Solution to Problem

A shelf allocation assistance apparatus according to one aspect of the present invention includes generation means for generating a plurality of shelf allocation candidates each indicating a state where a plurality of products including a specified product are displayed on a product shelf; prediction means for predicting sales of the specified product in the plurality of shelf allocation candidates, based on a relationship between a positional relationship among products displayed on the product shelf and sales of products; and selection means for selecting a shelf allocation candidate, based on a result of the prediction.

A shelf allocation assistance system according to one aspect of the present invention includes an imaging device that captures an image of a product shelf; an inventory management apparatus that manages an inventory of a store in which the product shelf is arranged; and a shelf allocation assistance apparatus, wherein the shelf allocation assistance apparatus includes: generation means for generating a plurality of shelf allocation candidates each indicating a state where a plurality of products including a specified product included in the inventory are displayed on the product shelf; prediction means for predicting sales of the specified product in the plurality of shelf allocation candidates, based on a relationship between a positional relationship among products displayed on the product shelf and sales of products; and selection means for selecting a shelf allocation candidate, based on a result of the prediction.

A shelf allocation assistance method according to one aspect of the present invention includes generating a plurality of shelf allocation candidates each indicating a state where a plurality of products including a specified product are displayed on a product shelf; predicting sales of the specified product in the plurality of shelf allocation candidates, based on a relationship between a positional relationship among products displayed on the product shelf and sales of products; and selecting a shelf allocation candidate, based on a result of the prediction,

A shelf allocation assistance method according to one aspect of the present invention includes capturing an image of a product shelf; generating a plurality of shelf allocation candidates each indicating a state where a plurality of products including a specified product included in an inventory of a store in which the product shelf is arranged are displayed on the product shelf; predicting sales of the specified product in the plurality of shelf allocation candidates, based on a relationship between a. positional relationship among products displayed on the product shelf and sales of products; and selecting a shelf allocation candidate, based on a result of the prediction.

Note that a computer program for causing a computer to implement the above-described apparatus, system, or method, and a computer-readable non-transitory recording medium storing the computer program are also encompassed in the scope of the present invention.

### Advantageous Effects of Invention

According to the present invention, it is possible to generate recommended shelf allocation indicating a display state of the products, including a state representing that a specified product is displayed on the shelf in such a manner to make the products sold good.

### BRIEF DESCRIPTION OF DRAWINGS

FIG. 1 is a functional block diagram illustrating an example of a functional configuration of a shelf allocation assistance apparatus according to a first example embodiment of the present invention;

FIG. 2 is a diagram illustrating an example of an overall configuration of a shelf allocation assistance system according to a second example embodiment of the present invention;

FIG. 3 is a functional block diagram illustrating an example of a functional configuration of a shelf allocation assistance apparatus of the shelf allocation assistance system according to the second example embodiment of the present invention;

FIG. 4 is a diagram illustrating an example of arrangement candidates generated by a generation unit;

FIG. 5 is a diagram illustrating an example of shelf allocation candidates generated by the generation unit;

FIG. 6 is a flowchart illustrating an example of a flow of processing of the shelf allocation assistance apparatus according to the second example embodiment of the present invention;

FIG. 7 is a functional block diagram illustrating an example of a functional configuration of a shelf allocation assistance apparatus according to a third example embodiment of the present invention;

FIG. 8 is a diagram illustrating an example of an overall configuration of a shelf allocation assistance system according to a fourth example embodiment of the present invention;

FIG. 9 is a diagram illustrating a scene in which the shelf allocation assistance system according to the fourth example embodiment of the present invention is used;

FIG. 10 is a functional block diagram illustrating an example of a functional configuration of the shelf allocation assistance apparatus according to the fourth example embodiment of the present invention;

FIG. 11 is a diagram illustrating an example of a captured image obtained by capturing an image by a photographing device;

FIG. 12 is a diagram illustrating processing for generating arrangement candidates by the generation unit;

FIG. 13 is a flowchart illustrating an example of a flow of processing of a shelf allocation assistance apparatus according to the fourth example embodiment of the present invention; and

FIG. 14 is a diagram illustrating a hardware configuration of a computer (information processing apparatus) capable of implementing each example embodiment of the present invention.

### EXAMPLE EMBODIMENTS

### First Example Embodiment

A first example embodiment of the present invention will be described with reference to the drawings. In this example embodiment, a basic configuration of the present invention for solving the problems will be described. FIG. 1 is a functional block diagram illustrating an example of a functional configuration of a shelf allocation assistance apparatus 10 according to this example embodiment. As illustrated in FIG. 1, the shelf allocation assistance apparatus 10 according to this example embodiment includes a generation unit 11, a prediction unit 12, and a selection unit 13.

The generation unit 11 generates a plurality of shelf allocation candidates indicating a state where a plurality of products including specified products are displayed on a product shelf. Examples of the specified products include products that are desired to be sold good by a seller through an input unit, which is not illustrated, products with a large quantity of stock, and products whose best-before date, expiration date, or validity date is due to expire shortly. All the inventory products may be the specified products. The generation unit 11 outputs the plurality of generated shelf allocation candidates to the prediction unit 12.

The prediction unit 12 receives the plurality of shelf allocation candidates from the generation unit 11. Further, the generation unit 11 predicts sales of specified products in the plurality of shelf allocation candidates based on a relationship between a positional relationship among the products displayed on the product shelf and the sales of the products: The relationship between the positional relationship among the products and the sales of the products are represented by, for example, a weight relating to each shelf stage of the product shelf for each product name. Altereratively, the relationship between the positional relationship among the products and the sales of the products are represented by a weight relating to each shelf stage for each product type, a weight relating to each shelf stage for each adjacent product name, or a weight relating to each shelf stage for each adjacent product type. The prediction unit 12 outputs the prediction result to the selection unit 13.

The selection unit 13 receives the prediction result from the prediction unit 12. Further, the selection unit 13 selects shelf allocation candidates based on the received prediction result. The selection unit 13 selects, for example, a shelf allocation candidate with highest predicted sales (also referred to as predicted sales) among the plurality of shelf allocation candidates. In this case, the magnitude of predicted sales may be the number of products with predicted sales, or may be the amount of predicted sales.

For example, assume that the number of predicted sales of product A as a certain shelf allocation candidate (referred to as a shelf allocation candidate AA) is five, and the number of predicted sales of product B is four, and assume that the number of predicted sales of product A as another shelf allocation candidate (referred to as a shelf allocation candidate BB) is seven, and the number of predicted sales of product B is one. At this time, the selection unit 13 may calculate a total of predicted sales of products for each shelf allocation candidate, and may select the shelf allocation candidate AA with a larger total of predicted sales. Further, the selection unit 13 may select the shelf allocation candidate BB which is a shelf allocation candidate to be predicted when maximum predicted sales of seven are predicted.

Thus, the shelf allocation assistance apparatus 10 according to this example embodiment predicts sales of the specified products based on the relationship between the positional relationship among the products and the sales of the products, and selects shelf allocation candidates based on the prediction result.

Accordingly, it can be said that the display locations of the specified products and the relationship between the display locations of the specified products and other products that are included in the selected shelf allocation candidates affect the sales. Therefore, the shelf allocation assistance apparatus 10 according to this example embodiment can generate recommended shelf allocation indicating a display state of products, including a state representing that the specified products are displayed on the shelf in such a manner to make the specified products sold good. A seller can perform a shelf allocation service based on the recommended shelf allocation based on the relationship between the locations of the products and the sales, and thus the shelf allocation assistance apparatus 10 according to this example embodiment can effectively assist the shelf allocation service.

### Second Example Embodiment

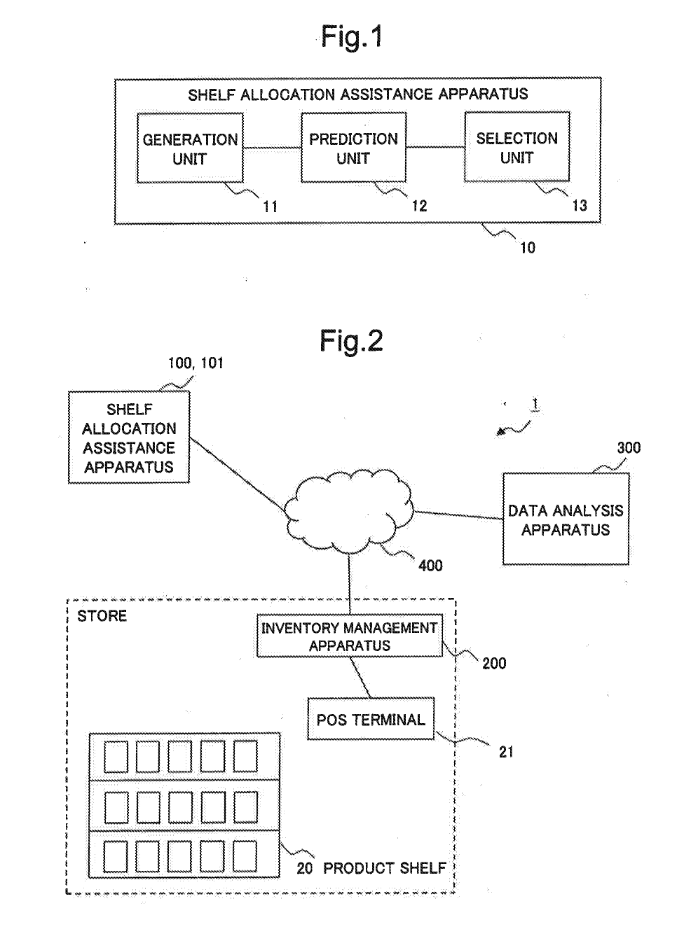

Next, a second example embodiment of the present invention based on the first example embodiment described above will be described with reference to the drawings. FIG. 2 is a diagram illustrating an example of an overall configuration of a shelf allocation assistance system 1 according to this example embodiment. The shelf allocation assistance system 1 illustrated in FIG. 2 includes a shelf allocation assistance apparatus 100, an inventory management apparatus 200, and a data analysis apparatus 300. The shelf allocation assistance apparatus 100 includes the configuration of the shelf allocation assistance apparatus 10 described above. Note that the shelf allocation assistance system 1 illustrated in FIG. 2, which illustrates a configuration specific to the present invention, and the shelf allocation assistance system 1 illustrated in FIG. 2 may also include members that are not illustrated in FIG. 2, as a matter of course.

The shelf allocation assistance apparatus 100, the inventory management apparatus 200, and the data analysis apparatus 300 are communicably connected to one another via a network 400. A communication means among the apparatuses may be wired or wireless communication, or may be communication via a mobile communication network, a public line network, a LAN (Local Area Network), or a WAN (Wide Area Network). Thus, various methods can be employed as the communication method used among the apparatuses, and are not essential to this example embodiment, and thus detailed descriptions thereof are omitted.

The inventory management apparatus 200 manages the inventory of products in a store. The inventory management apparatus 200 receives sales data indicating sales for each product name from one or more POS (Point Of Sales) terminals 21, and manages the inventory based on the received sales data and order data. Note that the order data may be transmitted from an ordering device which is not illustrated.

Note that FIG. 2 illustrates a configuration in which the inventory management apparatus 200 is installed in each store, but instead the inventory management apparatus 200 may be a server provided in a location different from each store. In this case, the inventory management apparatus 200 manages the inventories of a plurality of stores for each store. Further, the inventory management apparatus 200 may be integrally formed with the POS terminal 21. The sales data described herein refers to typical POS data, such as a sales amount or the number of sales of a certain product, but this example embodiment is not limited to these examples. Information about the inventories managed by the inventory management apparatus 200 includes a product name, the number of products, a product type, and the like but this example embodiment is not limited to these examples. For example, the information about the inventories may include a period of each product (a validity date, an expiration date, or a best-before date). The inventory management apparatus 200 transmits the information about the inventories to he managed to the shelf allocation assistance apparatus 100.

The data analysis apparatus 300 is an apparatus that analyzes the relationship between the positional relationship among the products and the sales of the products. A method for analysis, by the data analysis apparatus 300, the relationship between the positional relationship among the products and the sales of the products is, for example, an analysis based on a captured image and sales data. The method for analyzing, by the data analysis apparatus 300, the positional relationship among the products and the relationship among the sales of the products will be described below. However, the example embodiment may use analysis results obtained by a method other than the analysis method described below.

The data analysis apparatus 300 according to this example embodiment uses a captured image obtained by capturing an image of a product shelf as learning data, and recognizes products included in the captured image. Further, the data analysis apparatus 300 specifies locations where the recognized products are arranged on the product shelf.

Furthermore, the data analysis apparatus 300 receives sales data indicating sales for the product name from, for example, the POS terminal 21. The sales data received by the data analysis apparatus 300 from the POS terminal 21 may be similar to the sales data received by the inventory management apparatus 200, or may be sales data on dates that is different from the sales data received by the inventory management apparatus 200. The sales data received by the data analysis apparatus 300 may be data that can be used when the relationship between the positional relationship among the products and the sales of the products are analyzed.

The data analysis apparatus 300 analyzes the relationship between the positional relationship among the products and the sales of the products based on the locations where specified products are arranged and the sales data on the products. The results of analysis by the data analysis apparatus 300 are also referred to as relationship information hereinafter.

For example, the data analysis apparatus 300 uses information (e.g., a product name) indicating recognized products and locations where the recognized products are arranged on the product shelf and converts the information into a feature vector f(product name, shelf stage) using the product name and each shelf stage of the product shelf as variables. For example, it is assumed that each component of the feature vector f is represented by the number of certain products arranged on a certain stage. Specifically, “f(product A, 1)=1” indicates that a product having a product name “product A” is arranged on a first stage of the product shelf. Note that, for example, f(product A, 1) is described as below.

The data analysis apparatus 300 uses the feature vector f to perform a data analysis for each product name. A data analysis for a product having a product name “product A” will be described below. The feature vector for the product A is described as f_{A}. Data for analysis used for the data analysis is represented by the following data sets (1) and (2).
(1) A data set including a feature vector f_{A}=(f_{A1}, f_{A2}, f_{A3}, f_{A4}, f_{A5})=(1, 0, 0, 2, 2) for the product A in a certain store, and a sales amount (y_{A})=1000 for the product A in the same store.
(2)A data set including a feature vector f_{A}=(f_{A1}, f_{A2}, f_{A3}, f_{A4}, f_{A5})=(0, 3, 1, 4, 0). for the product A in another store, and a sales amount (y_{A})=3000 for the product A in the same store.

Note that the number of sets of data for analysis is not limited to two, But instead a plurality of sets of data for analysis may be used. While this example embodiment illustrates an example in which two sets of data for different stores are used, but instead a data set generated from. sales data on different dates in one store may be used.

The feature vector f, for the product A includes a number of components corresponding to the number of stages of a product shelf. As described above, the value of each component indicates the number of arranged products. As is obvious from the above data set (1), one product A is arranged on a first stage of a product shelf arranged in a certain store, no products are arranged on second and third stages, and two products are arranged on each of fourth and fifth stages.

The data analysis apparatus 300 calculates θ_{A} which satisfies the following expression (1) by using the data for analysis.

[Expression 1]

Minimize∥y_{A}−Σθ_{Ai}f(A, i)∥ (1)

In Expression (1), i represents a stage of a shelf (i=1, 2, 3, 4, 5).

The data analysis apparatus 300 uses the data for analysis to express θ_{A}, which is a result of analyzing the data (analysis result), as, for example, θ_{A}=(f_{A1}, f_{A2}, f_{A3}, f_{A4}, f_{A5})=(500, 800, 100, 400, 100). Each component θ_{Ai}of θ_{A}, which is the analysis result in this example embodiment, indicates a weight relating to each shelf stage of the product shelf for the product A. A component with a greater weight corresponds to a shelf stage with higher sales of the product A. Accordingly, the example of the analysis result described above shows that the sales of the product A arranged on the second stage are highest. As described above, the data analysis apparatus 300 specifies the position of the shelf stage with highest sales for each product name.

One or more types of products are displayed on a product shelf 20 having a plurality of shelf stages as illustrated in FIG. 2. On the product shelf 20, products having a certain product name and other products having a product name that is the same as the product name or different from the product name are displayed vertically or horizontally in many cases. A plurality of products displayed on each shelf stage is included in the product shelf 20 in this manner. Accordingly, this weight is determined in consideration of the relationship between the positional relationship between products displayed on a certain shelf stage and products displayed on another shelf stage, and sales of the products.

Note that in the data analysis apparatus 300 according to this example embodiment, the sales amount is used as the value of y_{A} used for analysis, but instead, for example, the number of sales may be used. At this time, when the sales data includes the sales amount of certain products and a unit price of the products and does not include the number of sales, the data analysis apparatus 300 may calculate the number of sales by dividing the sales amount by the unit price and use the number of sales as the value of y_{A}.

Further, the data analysis apparatus 300 may use, as an analysis method, a regression analysis (regression) method, such as a method of least squares as shown in Expression (1), or a classification method.

For example, when the above-mentioned value y_{A} is a specific value such as the sales amount or the number of sales, the data analysis apparatus 300 preferably performs the analysis using the regression analysis method. As the regression analysis method, for example, linear regression, a maximum likelihood method, Bayesian linear regression, or a neural network may be used in addition to the above-mentioned method of least squares.

When y_{A} represents, for example, a degree of sales, the data analysis apparatus 300 preferably performs the analysis using the classification method. A case where y_{A} represents the degree of sales is, for example, a case where y_{A} is a value represented in 10 steps of 1 to 10 according to the sales. As the classification method, for example, a generation model such as Naive Bayes, logistic. regression, a support vector machine, a neural network, nearest neighbor classification, or a decision tree may be used. In this manner, the data analysis apparatus 300 can appropriately select the analysis method according to the content (e.g., the type of the value y) of the learning data.

As described above, the analysis result output from the data analysis apparatus 300 indicates, for each product name, for example, a weight relating to each shelf stage of the product shelf 20 illustrated in FIG. 2. Note that the analysis result output from the data analysis apparatus 300 is not limited to each product name, but instead may indicate a weight relating to each shelf stage for, for example, each product type, each adjacent product name, or each adjacent product type, Further, the analysis result output from the data analysis apparatus 300 may indicate a weight for each product name with respect to an adjacent product adjacent to a product indicated by the product name. The analysis result may indicate a combination thereof. The adjacent product refers to a product adjacent to at least one of the products arranged horizontally, or adjacent to at least one of the products arranged vertically, within a predetermined range.

The data analysis apparatus 300 transmits the analysis result to the shelf allocation assistance apparatus 100 as relationship information indicating the relationship between the positional relationship among the products and the sales of the products. Note that the data analysis apparatus 300 may be integrally formed with the shelf allocation assistance apparatus 100 as an analysis unit.

### (Shelf Allocation Assistance Apparatus 100)

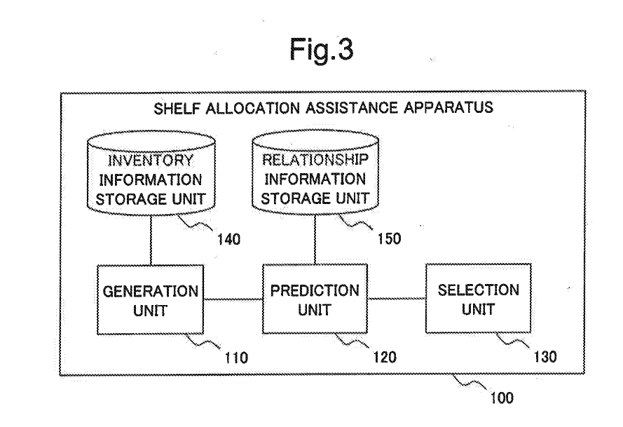

FIG. 3 is a functional block diagram illustrating an example of a functional configuration of the shelf allocation assistance apparatus 100 of the shelf allocation assistance system 1 according to this example embodiment. Note that FIG. 3 illustrates a configuration specific to the present invention, and the shelf allocation assistance apparatus 100 illustrated in FIG. 3 may include members that are not illustrated in FIG. 3, as a matter of course.

As illustrated in FIG. 3, the shelf allocation assistance apparatus 100 includes a generation unit 110, a prediction unit 120, a selection unit 130, an inventory information storage unit 140, and a relationship information storage unit 150. Note that the inventory information storage unit 140 and the relationship information storage unit 150 may be implemented by one storage unit. The inventory information storage unit 140 and the relationship information storage unit 150 may be respectively implemented by storage devices separate from the shelf allocation assistance apparatus 100.

The inventory information storage unit 140 stores information inventory information) about an inventory transmitted from the inventory management apparatus 200. The relationship information storage unit 150 stores the relationship information transmitted from the data analysis apparatus 300. Note that the shelf allocation assistance apparatus 100 need not necessarily include the inventory information storage unit 140 and the relationship information storage unit 150, in this case, the shelf allocation assistance apparatus 100 may be configured to communicate with the inventory management apparatus 200 and the data analysis apparatus 300 and acquire information necessary for processing described below.

The generation unit 110 receives information about products desired to be sold by a seller, through, for example, the input unit which is not illustrated, and specifies the products indicated by the received information as specified products. Further, the generation unit 110 may refer to the inventory information storage unit 140 and set, for example, products with a large quantity of stock or products whose best-before date, expiration date, or validity date is due to expire shortly, as specified products. The specified products may be all inventory products.

The generation unit 110 generates arrangement candidates indicating product candidates including at least one of the specified products as product candidates to be arranged at an arrangeable location indicating a position on the product shelf where the one or more specified products can be arranged. For example, assume that the product A is a specified product, and a two-stage product shelf including two slots on each shelf stage is used as the product shelf on which the products are displayed. Assuming that the first stage is the arrangeable location of the product A, the generation unit 110 generates product candidates to be arranged on this arrangeable location as arrangement candidates. In this example embodiment, since the number of specified products is one, i.e., the product A, the generation unit 110 includes the product A in the arrangement candidates. At this time, the generation unit 110 generates arrangement candidates for all arrangeable locations (by round-robin). In this example, as described above, the arrangeable locations are two locations, i.e., the first slot on the first stage (hereinafter referred to as (1, 1)), and the second slot on the first stage (hereinafter referred to as (1, 2)). Accordingly, the generation unit 110 generates the arrangement candidates for the two locations. In the case of this example, since the arrangeable locations are two locations, the number of products that can be arranged at the arrangeable locations is two. Accordingly, the generation unit 110 generates the arrangement candidates in such a manner that at least one of the two products is the product A.

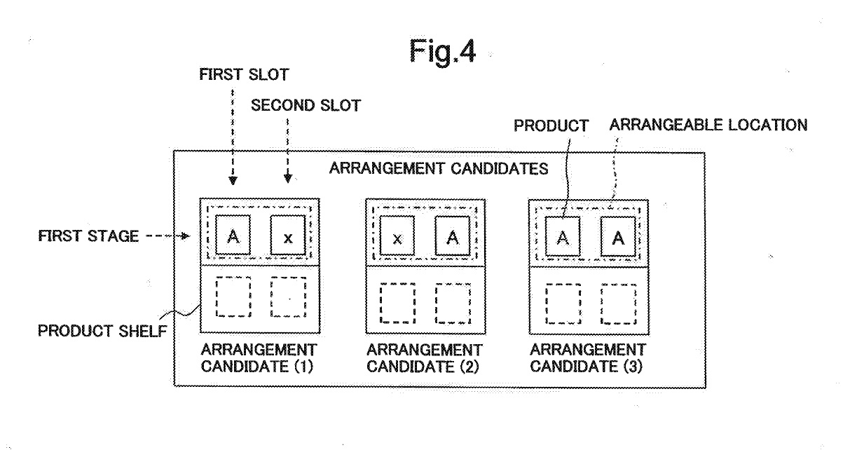

FIG. 4 illustrates an example of specified arrangement candidates. The generation unit 110 generates product arrangement candidates including the product A that are arranged at the arrangeable locations as illustrated in FIG. 4. Note that in FIG. 4, x represents a product other than the product A. When the products other than the product A are four types of products, i.e., a product B, a product C, and a product D, x represents any one of B, C, and D. In this manner, the generation unit 110 generates, by round-robin, product arrangement candidates including specified products that are arranged at the arrangeable locations.

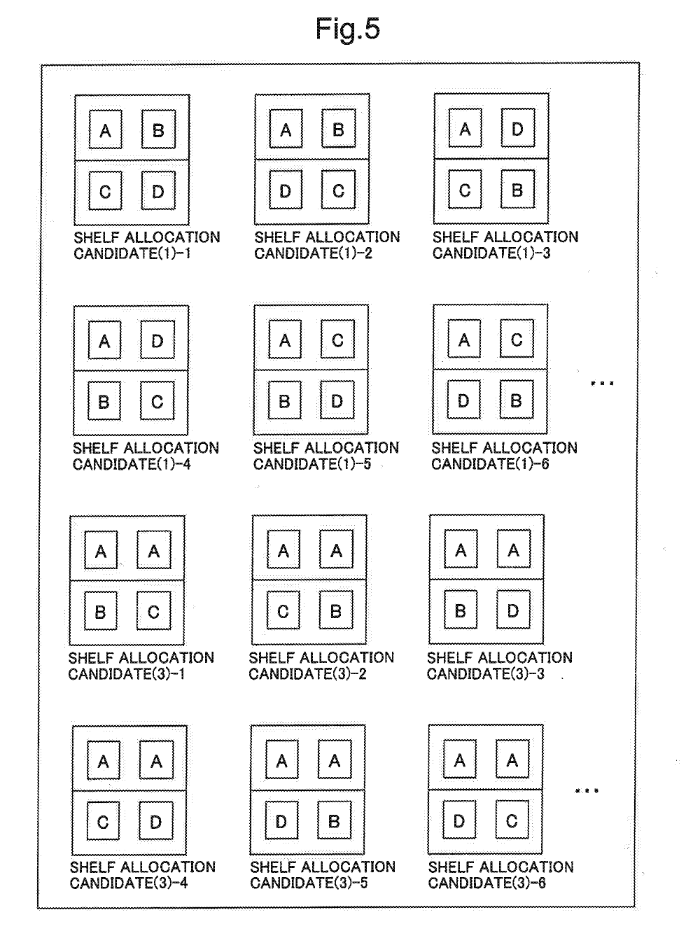

Further, the generation unit 110 generates a plurality of shelf allocation candidates each indicating a state where the products are displayed on the product shelf 20. For example, when the inventory products other than the product A are the product B, the product C, and the product D, the generation unit 110 generates shelf allocation candidates as illustrated in FIG. 5. As described above, the arrangeable location includes the product A which is the specified product, and the shelf allocation candidates generated by the generation unit 110 include the product A. Accordingly, it can also be said that the generation unit 110 generates shelf allocation candidates each indicating a state where a plurality of products including the product A are displayed on the product shelf 20.

Note that the shelf allocation candidates illustrated in FIG. 5 are examples of shelf allocation candidates including an arrangement candidate (1) illustrated in FIG. 4 and shelf allocation candidates including an arrangement candidate (3) illustrated in FIG. 4. In this example embodiment, the generation unit 110 obtains all combinations (by round-robin) of display locations of inventory products for a location (a second stage in FIG. 4) other than the location where the products are arranged as indicated by the arrangement candidates (arrangeable locations), and generates the shelf allocation candidates based on the obtained combinations. As described above, since the inventory products are the products B to D, the generation unit 110 generates combinations of products to be arranged for all the products B to D in each slot on the second stage of the product shelf. Note that the products to be arranged at locations other than the arrangeable locations may be one type of product or may be different types of products. The products to be arranged at locations other than the arrangeable locations may include specified products (in this case, the product A).

Note that the arrangeable locations of the specified products may be all slots on all shelf stages of the product shelf. In this case, the generation unit 110 outputs the generated arrangement candidates as the shelf allocation candidates.

The generation unit 110 outputs the plurality of generated shelf allocation candidates, as well as specified product information indicating specified products (in the above example, the product A), to the prediction unit 120.

The prediction unit 120 receives, from the generation unit 110, the plurality of shelf allocation candidates generated by the generation unit 110, together with the specified product information. The prediction unit 120 predicts sales of products indicated by the received specified product information for each of the plurality of received shelf allocation candidates based on the relationship information of the relationship information storage unit 150.

As described above, the relationship information is information as indicated by the following items (1) to (5):
(1) a weight relating to each shelf stage for each product name;
(2) a weight relating to each shelf stage for each product type;
(3) a weight relating to each shelf stage for each adjacent product name;
(4) a weight relating to each shelf stage for each adjacent product type; and
(5) a weight with respect to an adjacent product adjacent to a product indicated for each product name by the product name.

Note that the relationship information may be a combination of the above items (1) to (5).

For example, in the case of “shelf allocation candidate (1)-1” illustrated in FIG. 5, the product A is located on the first stage. Assume that the relationship information θ_{A} indicated by the above item (1) is represented by θ_{A}=(0.9, 0.5). This relationship information θ_{A}, represents the weight relating to each shelf stage about the product A, and indicates that the weight relating to the first stage is 0.9 and the weight relating to the second stage is 0.5, The prediction unit 120 predicts the sales of the product A in the shelf allocation candidate (1)-1 by using the above-mentioned relationship information θ_{A}. In the case of “shelf allocation candidate (1)-1” illustrated in FIG. 5, since the product A is located on the first stage, the sales of the product A are predicted using the weight 0.9 relating to the weight of the first stage.

Further, for example, in the case of “shelf allocation candidate (1)-1” illustrated in FIG. 5, the product that is adjacent to the right side of the product A is the product B. Assume that the relationship information 0 indicated by the above item (3) is expressed as 0=(adjacent product name, weight relating to the first stage, weight relating to the second stage)=(product B, 0.3, 0.2). This relationship information θ indicates that the weight relating to the first stage is 0.3 and that the weight relating to the second stage is 0.2 when a product name of the adjacent product is a product name B. The prediction unit 120 predicts the sales of the product A in the shelf allocation candidate (1)-1 by using the above-mentioned relationship information 0. In the case of “shelf allocation candidate (1)-1” illustrated in FIG. 5, the adjacent product name is the product B and the product B is located on the first stage. Accordingly, the sales of the product A are predicted using a weight 0.3 relating to the weight of the first stage.

Further, for example, assume that the relationship information θ_{A} indicated by the above item (5) is expressed as θ_{A}=(weight of product A as adjacent product, the weight of product B as adjacent product, the weight of product C as adjacent product, and weight of product D as adjacent product)=(0.5, 0.7, 0.3, 0.8). This relationship information θ_{A} indicates that the weight obtained when the adjacent product of the product A is the product A is 0.5, and the weight obtained when the adjacent product of the product A is the product B is 0.7. Similarly, this relationship information θ₄ indicates that the weight obtained when the adjacent product of the product A is the product C is 0.3 and the weight obtained when the adjacent product of the product A is the product D is 0.8. This shows that the weight obtained when the adjacent product of the product A is the product D is highest. The prediction unit 120 predicts the sales of the product A in the shelf allocation candidate (1)-1 by using the above-mentioned relationship information θ_{A}. For example, in the case of “shelf allocation candidate (1)-1” illustrated in FIG. 5, the product adjacent to the right of the product A is the product B. Accordingly, the sales of the product A are predicted using a weight 0.7 obtained when the product adjacent to the product A is the product B.

After that, the prediction unit 120 predicts the sales of the product A for all shelf allocation candidates. The relationship information on which the prediction by the prediction unit 120 is based may be any one of the above items (1) to (5), or may be a combination of the above items.

The prediction unit 120 outputs the predicted sales for each shelf allocation candidate as the prediction result to the selection unit 130.

The selection unit 130 receives the prediction result from the prediction unit 120. Further, the selection unit 130 selects, based on the received prediction result, a shelf allocation candidate with highest sales among the plurality of shelf allocation candidates. For example, when the sales of the product A in “shelf allocation candidates (1)-1”, “shelf allocation candidate (1)-2”, and “shelf allocation candidate (1)-3” are 50, 100, and 150, respectively, the selection unit 130 selects the “shelf allocation candidate (1)-3” with highest sales. Thus, it is obvious that the product display state more effective for sales of the product A is a state where the product A is displayed in the first slot on the first stage of the shelf, the product D is displayed on the right side of the product A, and the product C is displayed below the product A. The selection unit 130 can output the selected shelf allocation candidates as recommended shelf allocation indicating a product display state including a state where the specified products are displayed at more effective locations.

### (Flow of Processing in the Shelf Allocation Assistance Apparatus 100)

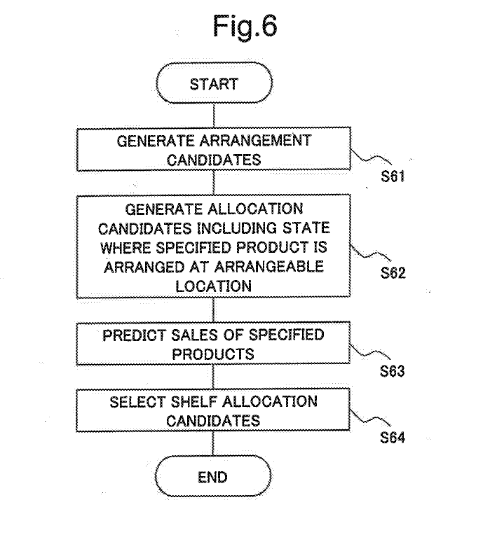

Next, a flow of processing in the shelf allocation assistance apparatus 100 will be described. FIG. 6 is a flowchart illustrating an example of a flow of processing in the shelf allocation assistance apparatus 100 according to this example embodiment.

As illustrated in FIG. 6, the generation unit 110 generates arrangement candidates as product candidates including the specified products that are arranged in the arrangeable locations on the product shelf (step S61). Further, the generation unit 110 generates a plurality of shelf allocation candidates including a state where the specified products are arranged in the arrangeable locations as indicated by the generated arrangement candidates (step S62).

Further, the prediction unit 120 predicts the sales of the specified products for each of the plurality of shelf allocation candidates generated in step S62 based on the relationship information (step S63),

After that, the selection unit 130 selects the shelf allocation candidate with highest sales among the plurality of shelf allocation candidates based on the predicted sales (prediction result) of the specified products for each shelf allocation candidate (step S64),

Thus, the processing for generating recommended shelf allocation in the shelf allocation assistance apparatus 100 according to this example embodiment is completed.

### Advantageous Effects

As described above, in the shelf allocation assistance apparatus 100 according to this example embodiment, the generation unit 110 generates arrangement candidates indicating candidates including at least one specified product as product candidates to be arranged in an arrangeable location where one or more specified products can be arranged. Further, the generation unit 110 generates shelf allocation candidates each indicating a state where a plurality of products on the product shelf including the specified products are displayed, including a state where at least one specified product is arranged in the arrangeable location as indicated by the generated arrangement candidates. The prediction unit 120 predicts sales of the specified products in each of the plurality of generated shelf allocation candidates based on relationship information indicating a relationship between a positional relationship among the products displayed on the product shelf and the sales of the products. After that, the selection unit 130 selects the shelf allocation candidate with highest predicted sales among the plurality of shelf allocation candidates based on the prediction result.

Since the prediction unit 120 predicts the sales of the specified products based on the relationship information, the prediction result shows the predicted sales according to the display location of each of the plurality of products including the specified products. It can be said that the sales of the shelf allocation candidate with highest predicted sales is affected by the relationship between the display location of the specified products and the display location of other products.

Accordingly, the shelf allocation assistance apparatus according to this example embodiment can generate recommended shelf allocation indicating a product display state including a state where specified products are displayed at more effective locations. Consequently, the shelf allocation assistance apparatus 100 according to this example embodiment can effectively assist the shelf allocation service, like in the shelf allocation assistance apparatus 10 according to the first example embodiment described above.

### MODIFIED EXAMPLE

In a modified example of this example embodiment, a modified example of relationship information will be described.

Some stores discount the products whose best-before date or the like is due to expire shortly, for example. Accordingly, the data analysis apparatus 300 may analyze the products based on information about the products whose expiration date is due to expire shortly, discounted products, and the like. For example, when the expiration date of another product (adjacent product) adjacent to a certain product is due to expire shortly, the data analysis apparatus 300 may analyze the relationship between the positional relationship between the certain product and the adjacent product and the sales of the products. Further, the data analysis apparatus 300 may analyze the sales of each of the products whose expiration date is due to expire shortly on each shelf stage, and may output the analysis result as relationship information.

The prediction unit 120 may predict sales based on the relationship information output from the data analysis apparatus 300, like in the to prediction unit 120 according to the second example embodiment described above.

Also in this configuration, the shelf allocation assistance apparatus 100 according to this modified example can obtain advantageous effects similar to those of the shelf allocation assistance apparatus 100 according to the second example embodiment described above,

While in the second example embodiment, the prediction unit 120 predicts sales of specified products, the prediction unit 120 may also calculate sales of other products. Further, for example, when there is a plurality of shelf allocation candidates with highest predicted sales, the selection unit 130 may select the shelf allocation candidate whose overall product sales included in the shelf allocation candidate is larger than the other candidates.

Also in this configuration, the shelf allocation assistance apparatus 100 can generate recommended shelf allocation indicating a product display state including a state where the specified products are displayed at more effective locations.

### Third Example Embodiment

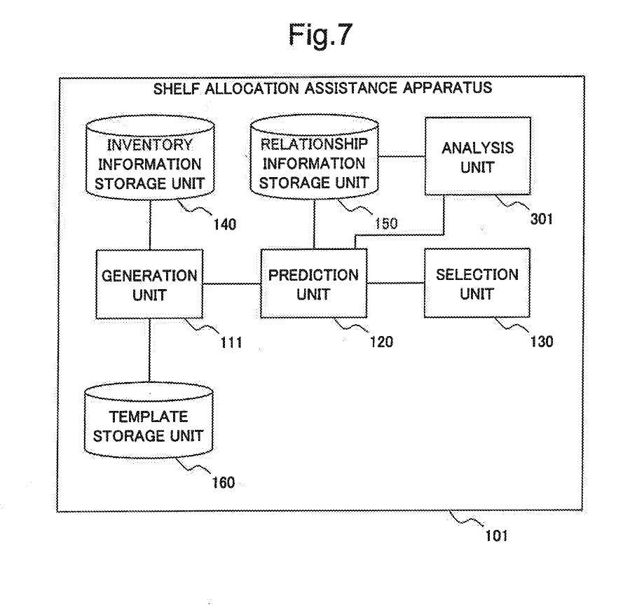

Next, a third example embodiment of the present invention will be described with reference to the drawings. FIG. 7 is a functional block diagram illustrating a functional configuration of a shelf allocation assistance apparatus 101 in the shelf allocation assistance system 1 according to this example embodiment. Note that, for convenience of explanation, members having the same functions as those of the members included in the drawings described in the second example embodiment described above are denoted by the same reference numerals and descriptions thereof are omitted. The overall configuration of the shelf allocation assistance system 1 according to this example embodiment is similar to the configuration of the shelf allocation assistance system 1 according to the second example embodiment illustrated in FIG. 2, and thus descriptions thereof are omitted.

As illustrated in FIG. 7, the shelf allocation assistance apparatus 101 includes a generation unit 111, a prediction unit 120, a selection unit 130, an inventory information storage unit 140, a relationship information storage unit 150, and a template storage unit 160. The shelf allocation assistance apparatus 101 illustrated in FIG. 7 includes an analysis unit 301 corresponding to the data analysis apparatus 300. Note that the analysis unit 301 has a function similar to that of the data analysis apparatus 300, and thus the description thereof is omitted. The shelf allocation assistance apparatus 101 has an analysis function, thereby making it possible to reduce a network load on the communication of relationship information.

Note that the inventory information storage unit 140, the relationship information storage unit 150, and the template storage unit 160 may be implemented by one storage unit. The inventory information storage unit 140, the relationship information storage unit 150, and the template storage, unit 160 may be respectively implemented by storage devices separate from the shelf allocation assistance apparatus 101.

The template storage unit 160 stores, as a template, information indicating a product display state in each of a plurality of stores. The template storage unit 160 may also store, as a template, information indicating, for example, a product display state recommended by the head office of a chain store.

The generation unit 111 generates, based on the template stored in the template storage unit 160, arrangement candidates including at least one of the specified products that are arranged at the arrangeable locations indicating the locations where the specified products can be arranged on the product shelf 20. First, the generation unit 111 specifies the specified products, like in the generation unit 110 described above. Further, the generation unit 111 generates, based on the template, arrangement candidates as product candidates to be arranged on the arrangeable locations where the at least one of specified products can be arranged. For example, assume that the product A is a specified product and a two-stage product shelf having two slots on each shelf stage is used as the product shelf on which products are displayed. Also assume that the first stage is an arrangeable location for the product A. Assume herein that a template includes information indicating a state where (product A, product A), (product A, product B), and (product C, product A) are arranged in the respective slots on the first stage. The state where the above-mentioned (product C, product A) are arranged indicates a state where the product C is arranged in the first slot on the first stage and the product A is arranged in the second slot. In this case, the generation unit 111 generates arrangement candidates based on this template. The generation unit 111 may generate, based on the template, all the above-mentioned (product A, product A), (product A, product B), and (product C, product A) as arrangement candidates, or may generate any one of the above candidates as arrangement candidates.

Further, the generation unit 111 generates a plurality of shelf allocation candidates each indicating a state where the products are arranged on the product shelf 20. As described above, the shelf allocation candidates include a state Where the product A is arranged in at least any one of the slots in the arrangeable location. Note that when there is a plurality of specified products, the shelf allocation candidates include a state where at least one specified product is arranged in at least any one of the slots in the arrangeable location. The generation unit 111 determines a combination of display locations of inventory products other than the product A based on the template stored in the template storage unit 160. Note that this example embodiment is not limited to this, and the generation unit 111 may determine, by round-robin, a combination of display locations of inventory products other than the product A, like in the second example embodiment described above. Further, the generation unit 111 generates shelf allocation candidates based on the determined combination.

Note that like in the second example embodiment, the generation unit 111 may obtain (by round-robin) arrangement candidates for all the locations where the specified products can be arranged, and may determine a combination of display locations of the inventory products other than the specified products based on the template stored in the template storage unit 160.

Note that all slots on all shelf stages of the product shelf may be set as the arrangeable locations for the specified products. In this case, the generation unit 111 outputs the arrangement candidates generated based on the template as shelf allocation candidates.

After that, like in the second example embodiment, the prediction unit 120 predicts sales of the specified products for each of the plurality of shelf allocation candidates, and the selection unit 130 selects shelf allocation candidates based on the prediction result.

As described above, the shelf allocation assistance apparatus 101 according to this example embodiment can obtain advantageous effects similar to those of the shelf allocation assistance apparatus 100 according to the second example embodiment described above. In addition, as described above, the shelf allocation assistance apparatus 101 according to this example embodiment generates a plurality of shelf allocation candidates, by using a template prepared in advance. This makes it possible to reduce the throughput of shelf allocation candidate generation processing, the throughput of sales prediction processing, and the like, as compared with the shelf allocation assistance apparatus 100 according to the second example embodiment described above, which leads to a reduction in a load on the shelf allocation assistance apparatus 101.

### Fourth Example Embodiment

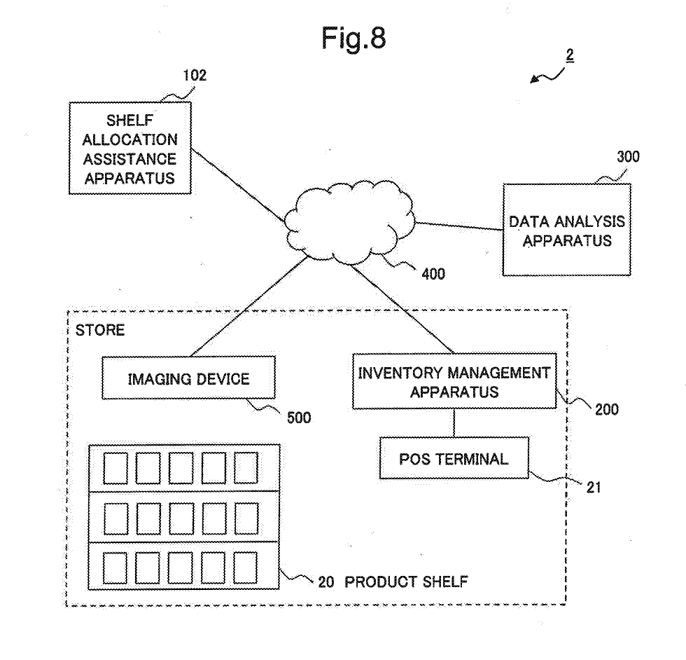

Next, a fourth example embodiment of the present invention will be described with reference to the drawings. FIG. 8 is a diagram illustrating an example of an overall configuration of a shelf allocation assistance system 2 according to this example embodiment. Note that, for convenience of explanation, members having the same functions as those of the members included in the drawings described in the above example embodiments are denoted by the same reference numerals and descriptions thereof are omitted.

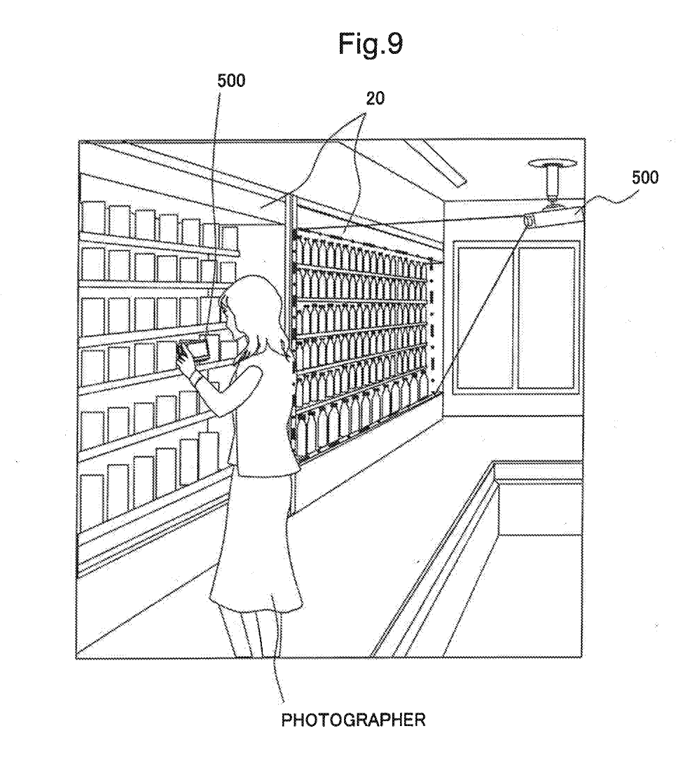

The shelf allocation assistance system 2 illustrated in FIG. 8 includes a shelf allocation assistance apparatus 102, the inventory management apparatus 200, the data analysis apparatus 300, and an imaging device 500. FIG. 9 is a diagram illustrating a scene in which the shelf allocation assistance system 2 according to this example embodiment is used. FIG. 9 is a functional block diagram illustrating an example of a functional configuration of the shelf allocation assistance system 2 according to this example embodiment.

In the shelf allocation assistance system 2 according to this example embodiment, the imaging device 500 captures an image of products displayed on the product shelf 20 in the store, and transmits the captured image to the shelf allocation assistance apparatus 102.

As illustrated in FIG. 9, the imaging device 500 may be, for example, a terminal having an imaging function, such as a mobile phone terminal, a smartphone, a digital camera, or a tablet, or may be a monitoring camera installed in a store. When the product shelf 20 whose image is captured by the imaging device 500 includes a location where no products are displayed (the location is referred to as an available slot), the shelf allocation assistance apparatus 102 outputs recommended shelf allocation for the product shelf 20. Thus, an operator who displays products can display the products effective for sales in the available slot by confirming the recommended shelf allocation on a display device which is not illustrated. In this manner, the shelf allocation assistance system 2 effectively assists the shelf allocation service for selecting the products to be displayed in the available slot.

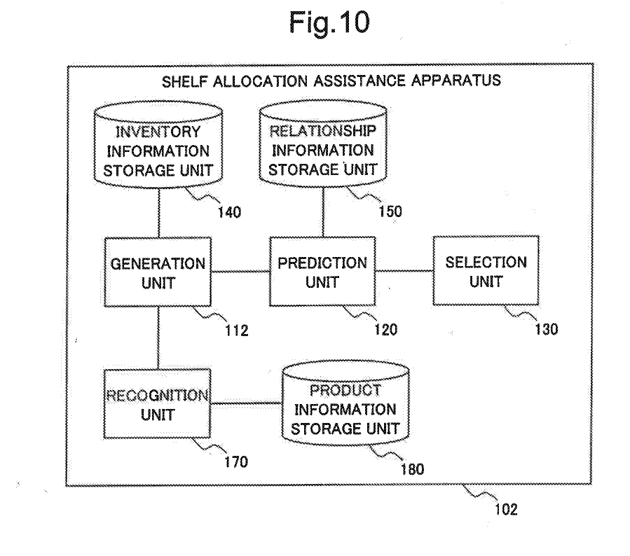

Referring next to FIG. 10, the functional configuration of the shelf allocation assistance apparatus 102 in the shelf allocation assistance system 2 according to this example embodiment will be described. FIG. 10 is a functional block diagram illustrating an example of the functional configuration of the shelf allocation assistance apparatus 102 according to this example embodiment. As illustrated in FIG. 10, the shelf allocation assistance apparatus 102 according to this example embodiment includes a generation unit 112, the prediction unit 120, the selection unit 130, the inventory information storage unit 140, the relationship information storage unit 150, a recognition unit 170, and a product information storage unit 180. The inventory information storage unit 140, the relationship information storage unit 150, and the product information storage unit 180 may be implemented by one storage unit. The inventory information 20. storage unit 140, the relationship information storage unit 150, and the product information storage unit 180 may be respectively implemented by storage devices separate from the shelf allocation assistance apparatus 102.

The product information storage unit 180 stores information for recognizing products included in the image captured by the imaging device 500. Specifically, the product information storage unit 180 stores an image of a product (also referred to as a master image) and/or a feature amount included in the image of the product in such a manner that the image of the product and/or the feature amount is associated with information for identifying the product (e.g., a product identifier, product name, or the like for identifying the product).

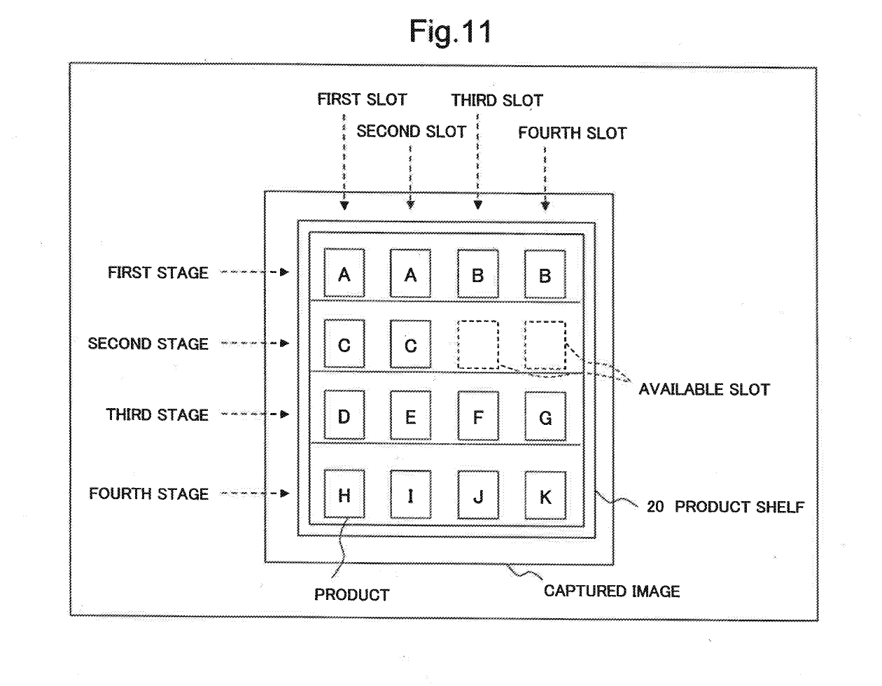

The recognition unit 170 receives, from the imaging device 500, the captured image obtained by capturing an linage of the product shelf 20 by the imaging device 500. Further, the recognition unit 170 recognizes the products included in the captured image from the captured image by referring to the information for recognizing the products stored in the product information storage unit 180. As a method for the recognition unit 170 to recognize the products, for example, a local feature amount, template, brightness, edge, outer shape, shape, color information, or depth may be used, or information other than these pieces of information may be used. The method for the recognition unit 170 to recognize the products is not particularly limited and a typical recognition method may be employed, and thus detailed descriptions thereof are herein omitted. Further, the recognition unit 170 outputs, to the generation unit 112, information (e.g., a product identifier or a product name) for identifying the recognized products as the recognition result, and information (e.g., coordinate values in the captured image) indicating locations on the captured image of the products. FIG. 11 illustrates an example of the captured image. The captured image is, for example, an image as illustrated in FIG. 11. The product shelf 20 included in the captured image is a product shelf having four shelf stages, and the number of products (the number of slots) that can be arranged on each shelf stage is four. A plurality of products is displayed in the product shelf 20 illustrated in FIG. 11. Alphabets in each product illustrated in FIG. 11 represent the last character of the product name in FIG. 11, for example, the product having the product name “product A” is represented by “A”.

The recognition unit 170 recognizes the products from the captured image. Further, the recognition unit 170 outputs the recognition result as well as the captured image to the generation unit 112.

Note that the recognition unit 170 may be implemented by a device separate from the shelf allocation assistance apparatus 102. In this case, the shelf allocation assistance apparatus 102 receives the recognition result from the above-mentioned separate device. Thus, the shelf allocation assistance apparatus 102 can reduce the processing load on the shelf allocation assistance apparatus 102. Further, the shelf allocation assistance apparatus 102 includes the recognition unit 170, thereby making it possible to reduce a network load associated with the transmission and reception of the recognition result.

The generation unit 112 receives the product recognition result as well as the captured image from the recognition unit 170. Further, the generation unit 112 determines the location where no products are displayed from the captured image. Specifically, the generation unit 112 specifies the available slot from the captured image. Note that the recognition unit 170 may specify the available slot. In this case, the recognition unit 170 may transmit the product recognition result as well as information indicating the location of the available slot. In the case of the captured image illustrated in FIG. 11, the generation unit 112 specifies the third slot on the second stage and the fourth slot on the second stage as available slots.

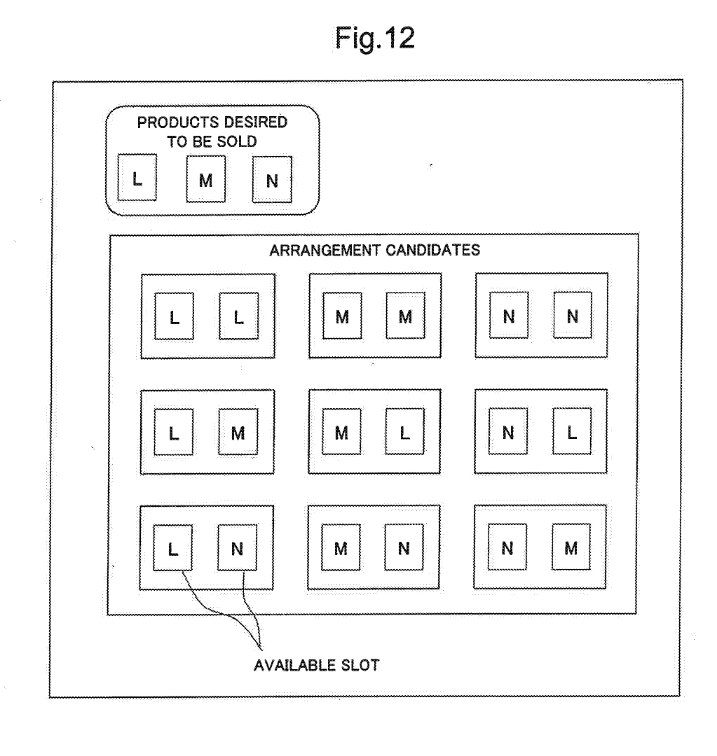

Each of the available slots is a location where the products can be arranged. Accordingly, the generation unit 112 generates one or more candidates including at least one specified product as product candidates to be arranged in the available slots. This process will be described with reference to FIG. 12. FIG. 12 is a diagram illustrating processing for generating arrangement candidates by the generation unit 112. As illustrated in FIG. 12, assume in this example embodiment that the specified products are products that are desired to be sold by a seller and the products are a product L, a product M, and a product N. Note that the specified products may be all the inventory products managed by the inventory management apparatus 200.

The generation unit 112 generates arrangement candidates as candidates when the specified products are arranged in the available slots. Note that, for convenience of explanation, the arrangement candidates illustrated in FIG. 12 correspond to the parts of two available slots in the product shelf.

The generation unit 112 generates, as arrangement candidates, any one of combinations of the specified products arranged for each of the two slots set as the arrangeable location. FIG. 12 illustrates nine arrangement candidates. In FIG. 12, the available slot located on the left side indicates the third slot on the second stage in FIG. 11, and the available slot located on the right side indicates the forth slot on the second stage in FIG. 11. For example, among the arrangement candidates illustrated in FIG. 12, the upper left arrangement candidate indicates that a combination of products arranged in the third slot on the second stage of the product shelf 20 and in the fourth slot of the second stage thereof is (product L, product L). Specifically, the upper left arrangement candidate indicates that the product candidates arranged in the third and fourth slots on the second stage of the product shelf 20 are products L.

Note that the arrangement candidates illustrated in FIG. 12 are a combination of specified products respectively arranged in the two slots set as the arrangeable location. However, this example embodiment is not limited to this. The generation unit 112 may generate any combination of products as long as the products arranged in one of the two slots set as the arrangeable location include the specified products. For example, the generation unit 112 may generate (product L, product A) as a combination of products arranged in the third slot on the second stage and the fourth slot on the second stage, respectively. This product A is the inventory product that is not the specified product. When only one slot is set as the arrangeable location, the generation unit 112 generates any one of the specified products as an arrangement candidate.

Note that like in the second example embodiment, the generation unit 112 may generate (by round-robin) arrangement candidates for all the arrangeable locations. Further, the generation unit 112 may generate arrangement candidates based on a template, like in the third example embodiment. In this case, the shelf allocation assistance apparatus 102 may have a configuration including the template storage unit 160, like in the shelf allocation assistance apparatus 101 according to the third example embodiment.

Further, the generation unit 112 generates shelf allocation candidates each indicating a state where at least one specified product is arranged at the arrangeable location based on the generated arrangement candidates, and the recognized products are arranged at the locations corresponding to the locations of the recognized products in the captured image. On the first stage of the product shelf 20 included in the captured image illustrated in FIG. 11, the product A, the product A, the product B, and the product B are arranged in this order from the left side. The recognition unit 170 recognizes the products and the locations thereof from the captured image. Accordingly, the generation unit 112 sets the state of the first stage included in the shelf allocation candidates as a state where the product A, the product A, the product B, and the product B are arranged in this order from the left side. Similarly, the generation unit 112 determines the products to be arranged on other shelf stages based on the recognition result.

Further, the generation unit 112 outputs the generated shelf allocation candidates to the prediction unit 120.

After that, like in the second example embodiment, the prediction unit 120 predicts sales of the specified products for each of the plurality of shelf allocation candidates, and the selection unit 130 selects shelf allocation candidates based on the prediction result.

### (Flow of Processing in the Shelf Allocation Assistance Apparatus 102)

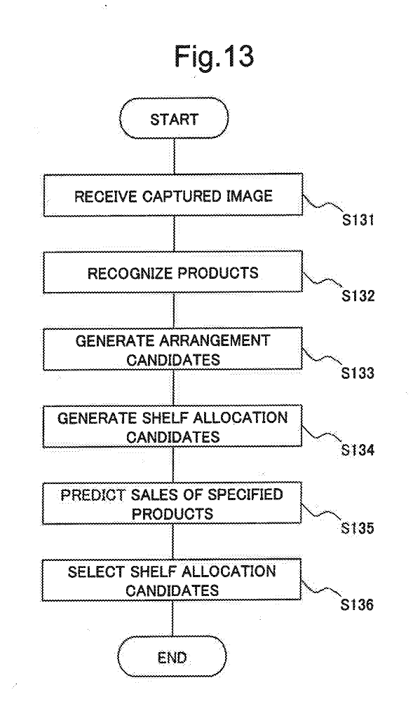

Next, a flow of processing in the shelf allocation assistance apparatus 102 will be described. FIG. 13 is a flowchart illustrating an example of a flow of processing in the shelf allocation assistance apparatus 102 according to this example embodiment,

As illustrated in FIG. 13, first, the recognition unit 170 receives a captured image obtained by capturing an image of the product shelf by the imaging device 500 (step S131). The recognition unit 170 recognizes products from the received captured image (step S 132).

After that, the generation unit 112 generates arrangement candidates as product candidates including the specified products that are arranged at the location (arrangeable location) that is determined by the recognition unit 170 to be a location where no products are displayed (step S133). Further, the generation unit 112 generates shelf allocation candidates each indicating a state where the specified products are arranged at the arrangeable location as indicated by the generated arrangement candidates, and the recognized products are arranged at the locations corresponding to the locations of the products recognized from the captured image in the captured image (step S134).

Further, the prediction unit 120 predicts sales of the specified products for each of the plurality of shelf allocation candidates generated in step S134 based on the relationship information (step S135).

After that, the selection unit 130 selects the shelf allocation candidate with highest sales among the plurality of shelf allocation candidates based on the predicted sales (prediction result) of the specified products for each of the shelf allocation candidates (step S136).

Thus, the processing for generating the recommended shelf allocation in the shelf allocation assistance apparatus 102 according to this example embodiment is completed.

As described above, like in the above example embodiments, the shelf allocation assistance system 2 according to this example embodiment can generate recommended shelf allocation indicating a product display state including a state where the specified products are displayed at more effective locations. Consequently, the shelf allocation assistance system 2 according to this example embodiment can effectively assist the shelf allocation service, like in the above example embodiments.

### Hardware Configuration Example

A hardware configuration example in which the shelf allocation assistance apparatuses (10, 100 to 102) according to the above example embodiments can be implemented will now be described. The above-described shelf allocation assistance apparatuses (10, 100 to 102) may be implemented as a dedicated apparatus, or may be implemented using a computer (information processing apparatus).

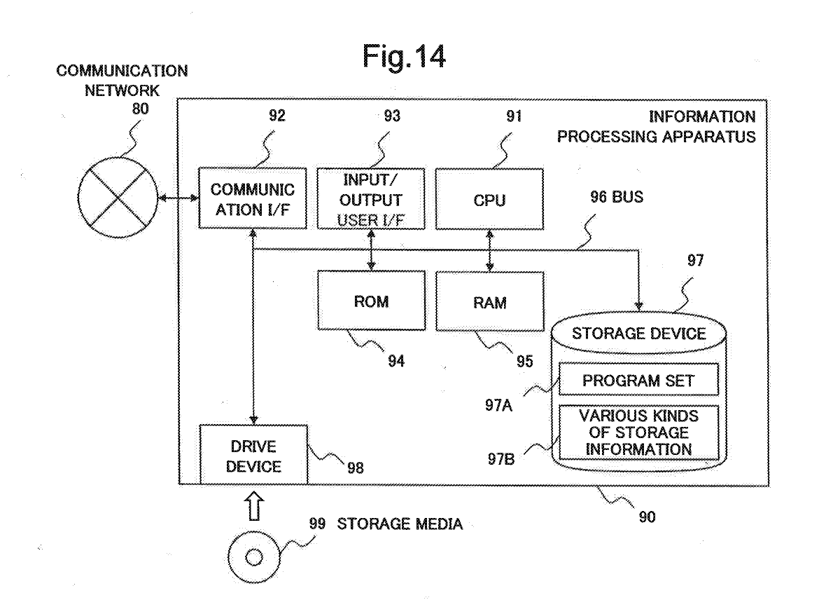

FIG. 14 is a diagram illustrating a hardware configuration of a computer (information processing apparatus) capable of implementing the example embodiments of the present invention.

Hardware of an information processing apparatus (computer) 90 illustrated in FIG. 14 includes a CPU (Central Processing Unit) 91, a communication interface (I/F) 92, an input/output user interface 93, a ROM (Read Only Memory) 94, a RAM (Random Access Memory) 95, a storage device 97, and a drive device 98 for a computer-readable storage medium 99, and these components are connected via a bus 96. The input/output user interface 93 is a man machine interface such as a keyboard, which is one example of an input device, or a display, which is an output device. The communication interface 92 is a typical communication means for the apparatuses (illustrated in FIGS. 1, 3, 7, and 10) according to the above example embodiments to communicate with external devices via a communication network 80. In the hardware configuration, the CPU 91 controls the overall operation of the information processing apparatus 90 to implement the shelf allocation assistance apparatuses (10, 100 to 102) according to the above example embodiments.

The present invention described above by illustrating the above example embodiments can be achieved by, for example, supplying a program (computer program) capable of implementing the processing described in the above example embodiments into the information processing apparatus 90 illustrated in FIG. 14, loading the program to the CPU 91, and causing the CPU 91 to execute the program. Note that the program may be, for example, a program capable of implementing various processing described in the flowcharts (FIGS. 6 and 13) referred to in the above example embodiments, or each unit (each block) illustrated in the apparatuses in the block diagrams illustrated in FIGS. 1, 3, 7, and 10.

The program supplied into the information processing apparatus 90 may be stored in a readable/writable transitory storage memory (95) or a non-volatile storage device (97) such as a hard disk drive. Specifically, in the storage device 97, a program set 97A is, for example, a program capable, of implementing the functions of each unit illustrated in the shelf allocation assistance apparatuses (10, 100 to 102) in the above example embodiments. Examples of various kinds of storage information 9713 include the shelf allocation candidates, the relationship information, the inventory information, the captured image, the recognition result, the template, the recommended shelf allocation described in the above example embodiments. In this case, however, in the implementation of the program in the information processing apparatus 90, the configuration unit for each program and module is not limited to each block illustrated in the block diagrams, and may be appropriately selected by those skilled in the art in the implementation.

In this case, as a method for supplying the program into the apparatus, typical procedures, such as a method for installing the program into the apparatus via various computer-readable recording media (99) such as a CD (Compact Disk)-ROM or a flash memory, or a method for downloading the program from the outside via the communication line (80) such as the Internet, may be currently adopted. In such cases, it can be recognized that the present invention is configured by a code (program set 97A) that constitutes the computer program, or the storage media (99) storing the code.

In the above example embodiments, a case where the functions of each block illustrated in the block diagrams are implemented by a software program is described as an example where the functions are executed by the CPU 95 illustrated in FIG. 14. However, some or all the functions of each block illustrated in the block diagrams may be implemented as a hardware circuit.

Note that the above example embodiments are preferred example embodiments of the present invention. The scope of the present invention is not limited only to the above example embodiments, and can be modified in various ways using corrections or substitutions of the above example embodiments by those skilled in the art without departing from the scope of the present invention,

This application is based upon and claims the benefit of priority from Japanese patent application No. 2015-116477, filed on Jun. 9, 2015, the disclosure of which is incorporated herein in its entirety by reference,

### REFERENCE SIGNS LIST

1 Shelf allocation assistance system
2 Shelf allocation assistance system
10 Shelf allocation assistance apparatus
11 Generation unit
12 Prediction unit
13 Selection unit
100 Shelf allocation assistance apparatus
101 Shelf allocation assistance apparatus
102 Shelf allocation assistance apparatus
110 Generation unit
111 Generation unit
112 Generation unit
120 Prediction unit
130 Selection unit
140 Inventory information storage unit
150 Relationship information storage unit
160 Template storage unit
170 Recognition unit
180 Product information storage unit
200 Inventory management apparatus
300 Data analysis apparatus
301 Analysis unit
400 Network
500 Imaging device
20 Product shelf
21 POS terminal

1. A shelf allocation assistance apparatus comprising:
generation unit which generates a plurality of shelf allocation candidates each indicating a state where a plurality of products including a specified product are displayed on a product shelf;
prediction unit which predicts sales of the specified product in the plurality of shelf allocation candidates, based on a relationship between a positional relationship among products displayed on the product shelf and sales of products; and
selection unit which selects a shelf allocation candidate, based on a result of the prediction.

2. The shelf allocation assistance apparatus according to claim 1, wherein the selection unit selects a shelf allocation candidate with highest predicted sales.

3. The shelf allocation assistance apparatus according to claim 1, wherein the generation unit generates an arrangement candidate indicating a candidate including at least one of the specified products as product candidates to be arranged at arrangeable locations where one or more of the specified products can be arranged on the product shelf, and generates the shelf allocation candidate indicating the display state including a state where at least one of the specified products are arranged at the arrangeable locations indicated by the generated arrangement candidate.

4. The shelf allocation assistance apparatus according to claim 3, wherein the generation unit generates the arrangement candidates for all the arrangeable locations.

5. The shelf allocation assistance apparatus according to claim 3, wherein the generation unit generates the arrangement candidate, based on a template prepared in advance.

6. The shelf allocation assistance apparatus according to claim 4, wherein
the plurality of products other than the specified products are products recognized from a captured image obtained by capturing an image of the product shelf, respectively,
the arrangeable location is a location that is determined from the captured image to be a location where no product is displayed, and
the generation unit generates the shelf allocation candidate by arranging at least one of the specified products at the arrangeable locations, and by arranging the recognized products at locations corresponding to locations in the captured image of the recognized products.

7. The shelf allocation assistance apparatus according to claim 6, further comprising recognition unit which recognizes a product from the captured image.

8. The shelf allocation assistance apparatus according to claim 3, wherein the generation unit determines all combinations of the plurality of products other than the specified product, arranged at arrangeable locations, and generates the shelf allocation candidates for the respective determined combinations.

9. The shelf allocation assistance apparatus according to claim 3, wherein the generation unit determines display locations of the plurality of products other than the specified product, based on a template prepared in advance, and generates the shelf allocation candidate for the determined display locations.

10. The shelf allocation assistance apparatus according to claim 1, wherein a relationship between a positional relationship among products displayed on the product shelf and sales of products is represented by information indicating at least one of a weight with respect to each shelf stage for at least one of each product name, each product type, each adjacent product name, and each adjacent product type, and a weight for each product name with respect to an adjacent product adjacent to a product indicated by the product name.

11. The shelf allocation assistance apparatus according to claim 10, wherein a relationship between a positional relationship among products displayed on the product shelf and sales of products is analyzed based on a period of each product.

12. The shelf allocation assistance apparatus according to claim 1, further comprising analysis unit which analysis a relationship between a positional relationship among products displayed on the product shelf and sales of products, based on a captured image obtained by capturing an image of a product, and sales data on a product.

13. A shelf allocation assistance system comprising:
an imaging device that captures an image of a product shelf;
an inventory management apparatus that manages an inventory of a store in which the product shelf is arranged; and
a shelf allocation assistance apparatus, wherein
the shelf allocation assistance apparatus includes:
generation unit which generates a plurality of shelf allocation candidates each indicating a state where a plurality of products including a specified product included in the inventory are displayed on the product shelf;
prediction unit which predicts sales of the specified product in the plurality of shelf allocation candidates, based on a relationship between a positional relationship among products displayed on the product shelf and sales of products; and
selection unit which selects a shelf allocation candidate, based on a result of the prediction.

14. The shelf allocation assistance system according to claim 13, wherein the selection unit selects a shelf allocation candidate with highest predicted sales.

15. The shelf allocation assistance system according to claim 13, wherein the generation unit generates an arrangement candidate indicating a candidate including at least one of the specified products and being arranged at an arrangeable location determined from a captured image captured by the imaging device to be a location where no product is displayed, and generates the shelf allocation candidate indicating a state where at least one of the specified products are arranged at the arrangeable locations, based on the generated arrangement candidate, and, at locations corresponding to locations in the captured image of products recognized from the captured image, the recognized products are arranged.

16. The shelf allocation assistance system according to claim 15, wherein the generation unit generates the arrangement candidates for all the arrangeable locations.

17. The shelf allocation assistance system according to claim 15, wherein the generation unit generates the allocation candidate, based on a template prepared in advance.

18. The shelf allocation assistance system according to claim 13, wherein a relationship between a positional relationship among products displayed on the product shelf and sales of products is represented by information indicating at least one of a weight with respect to each shelf stage for at least one of each product name, each product type, each adjacent product name, and each adjacent product type, and a weight for each product name with respect to an adjacent product adjacent to a product indicated by the product name.

19. The shelf allocation assistance system according to claim 18, wherein a relationship between a positional relationship among products displayed on the product shelf and sales of products is analyzed based on a period of each product.

20-21. (canceled)

22. A shelf allocation assistance method comprising:
generating a plurality of shelf allocation candidates each indicating a state where a plurality of products including a specified product are displayed on a product shelf;
predicting sales of the specified product in the plurality of shelf allocation candidates, based on a relationship between a positional relationship among products displayed on the product shelf and sales of products; and
selecting a shelf allocation candidate, based on a result of the prediction.

23-25. (canceled)
